(19) United States
(12) Patent Application Publication
(10) Pub. No.: US 2011/0262889 A1
(43) Pub. Date: Oct. 27, 2011

(54) DEVICE FOR PROMOTING LEARNING OF SKILLS AND CONCEPTS AND METHOD OF USING SAME

(75) Inventors: Marcel Prevuznak, Charleston, SC (US); James Hawkes, Charleston, SC (US); Merritt Crawford, Charleston, SC (US)

(73) Assignee: QUANT SYSTEMS, INC., Charleston, SC (US)

(21) Appl. No.: 12/764,353

(22) Filed: Apr. 21, 2010

(51) Int. Cl. G09B 7/00

(52) U.S. Cl. 434/327

(57) ABSTRACT

A method and apparatus for encouraging a student to continue practicing skills until mastery of the skills is achieved. The method and apparatus present assigned exercises sequentially to a student, and evaluates the student's response. An assignment comprising a finite number of questions, a maximum number of attempts to answer each of the finite number of questions, and a required minimum number of correct answers to the finite number of questions is designed for a user. A learning device presents the user with a question from the finite number of questions that has not been attempted by the user. If the user supplies an incorrect answer to the question, the user chooses to either accept the incorrect answer, or to repeat an attempt to answer the question with new parameters. If the maximum number of attempts to answer the question is not exhausted, the learning device supplies new parameters to the question and presents the question with new parameters to the user, and the learning device reduces the available maximum number attempts to answer the question by one.

### FIELD OF THE INVENTION

The present invention relates to the devices for promoting learning and processes of using those devices to promote learning.

### BACKGROUND OF THE INVENTION

Repeated practice of new skills, such as mathematic operations, allows students to become more comfortable, and thus gain more confidence with new skills and concepts, while reinforcing the students' abilities. There are currently computer based educational options available to demonstrate and practice skills. However, many students require sufficient gains to motivate them to continue practicing. Moreover, students need to feel comfortable that they can practice without being penalized, either academically or economically.

Many processes assign the student a score based on the number or percentage of questions the student answers correctly and incorrectly. Once the student receives a score, many students feel the assignment is complete and stop practicing. Simply receiving a score can reduce the student's motivation if the score is poor.

### SUMMARY OF THE INVENTION

The current invention is directed to a device for performing learning exercises and which sets options to allow the student to practice assigned skills without penalty. The student loads the assignment electronically on the device either via the internet or from a portable storage device. The student is presented with a series of exercises to complete. In one embodiment, the student is not provided with material substantive guidance during completion of the assignment, to ensure the student is able to perform the tasks without prompting or assistance. If the student answers an exercise incorrectly, the student is given the option to repeat the exercise with new parameters. The student is given new parameters upon each attempt to ensure the student is able to apply the knowledge to novel instances of the skill. Once the student has completed a set of skills, he or she is awarded full credit for their work regardless of the number of attempts required to complete the set. However, the student will not be awarded any credit until they the student shows sufficient mastery, thereby encouraging the student to keep working until mastery is achieved.

### DESCRIPTION OF THE DRAWINGS

FIG. 1 depicts an exemplary device according to the invention.

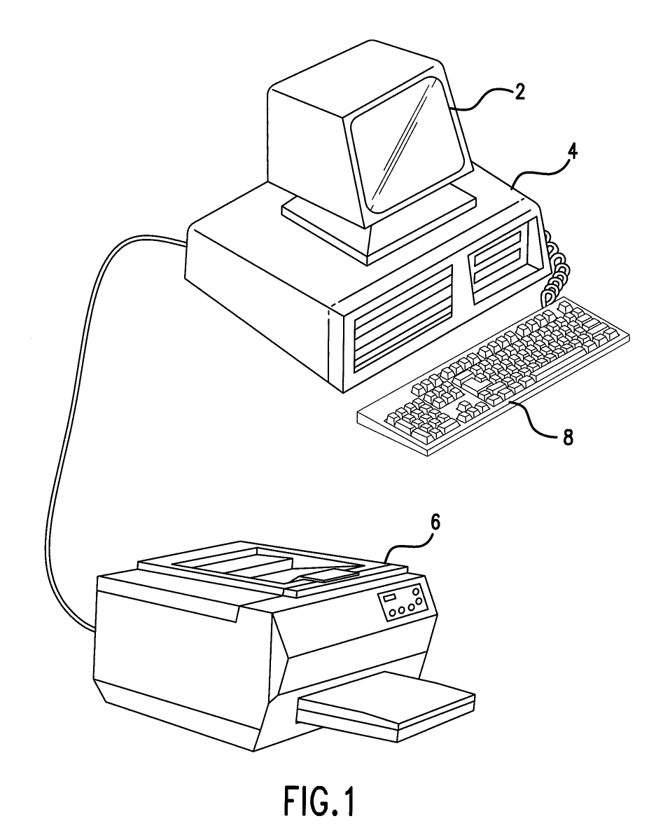

FIG. 2 is a flow chart demonstrating a method according to one embodiment of the invention.

### DETAILED DESCRIPTION OF PREFERRED EMBODIMENTS

A preferred embodiment of the invention is a device that provides a pedagogical process. A user interface of the device allows an instructor to assign exercises and set a limit on the number of times a student can repeat a specific skill exercise per session. The “limit” may be an unlimited number of times. The assignment and setting may be loaded to a device that is provided to the student, or the student may receive the assignment and setting on his or her device via download over the internet or by loading from a portable storage device.

In one embodiment of the invention the device presents a student with exercises one at a time. The student used device of this embodiment includes an interface for entering answers to the exercises presented. The device system evaluates the student's answer immediately at the time of submission. If the answer is evaluated to be incorrect, the student may be presented with the option of attempting the exercise again, or proceeding to a new exercise. The option provides the student with control over the learning experience, encouraging the student to take responsibility for learning and allowing the student to choose his or her preferred process of learning. The student may focus on a particular exercise until the student has learned the skill presented, or the student may proceed to other skill exercises. If the student chooses to attempt the exercise again, the student is presented with an exercise requiring the student to employ the same mental processes, but the exercise is presented with new randomly generated parameters, such as different numbers.

It is preferred that no material help or guidance is provided to the student while completing the exercises. When a student masters a task, such mastery is accomplished by the student alone, confirming that the student has developed a desired grasp of the material. By successfully completing exercises without guidance, the student's confidence is enhanced.

In a preferred embodiment, the device presents a predetermined number (as determined by the instructor) of exercises assigned by an instructor, or by the device on a default basis. Once the student completes the exercises with a satisfactory number of correct answers, the student receives full credit for the assignment. The student does not receive any credit for the assignment until successful completion of a predetermined number of the assigned exercises. The device does not limit the number of attempts to successfully complete the set of exercises, and the student may access the assignment on the device as many times as the student requires to successfully complete the exercises.

In one embodiment, if the student demonstrates a mastery of a sufficient number of skills in the skill set, but less than all of the skills, the device awards full credit for the set. However, the student will not receive credit until sufficient mastery of the set is demonstrated. This “all or none” approach requires the student to keep practicing until the material is master for the device to award credit. Therefore, the student is motivated to keep trying until the material is mastered, since credit is awarded by the device for the assignment, rather than awarding the student a score prior to the set of exercises being mastered by the student. The student is also rewarded for repeated practice and success by receiving full credit once mastery of the set of exercises is demonstrated, and no score or grade is awarded by the device that is indicative of incorrect answers. There is no penalty or reduction in the awarded results for incorrect answers.

In an embodiment, the instructor programs the device to allow multiple attempts to complete the set of exercises. Using the device, the student can choose to repeat a specific skill until they demonstrate mastery of the skill, or choose to proceed to another skill. The instructor programs the device to put additional control of the device and the use of the device in student hands. Allowing the student to choose how they use the device to master the assigned skills makes the student feel more comfortable, more confident, and in control, and thus more motivated to learn.

In one embodiment, the student user may pause a session at any point and return to that point later, or the student user can start a new session at any time. If a session ends due to exceeding the maximum number of incorrect answers (or failing to obtain the minimum number of correct answers), the student user may elect to start a practice session of the questions he missed. In one embodiment of the invention, the student user may attempt the assignment as many times as he would like or needs to, and in another embodiment, a maximum number of attempts, which may range from one to an unlimited number of attempts, may be set by the instructor.

In another embodiment, work is completed on a device that is not internet enabled. In yet another embodiment, work is completed while a device is not currently connected to the internet. In these embodiments, the student does not have extraneous concerns such as the inconvenience or expense that can be incurred obtaining internet access. More time and attention may be focused on mastering the assigned skills.

In an embodiment of the invention, the device is computer 4 having a display 2 that displays questions to a user. A keyboard 8 or other input device such as a mouse may be used to input answers to questions. The computer may communicate with a portable storage device 6. The computer may be programmable.

In an embodiment of the invention, an assignment is loaded into the learning device for presentation to a user by means of the display. The assignment comprises a finite number of questions, a maximum number of attempts to answer each of those, and a required minimum number of correct answers to the questions. The learning device presents the user with a question that has not been attempted. If the user supplies an incorrect answer to the question, the user chooses to either accept the incorrect answer, or to repeat an attempt to answer the question with new parameters. If the maximum number of attempts to answer the question is not exhausted, the learning device supplies new parameters to the question and presents the question with new parameters to the user, and the learning device reduces the available maximum number attempts to answer the question by one. The learning device continues to present the user with said question from the finite number of questions with new parameters until either the user supplies a correct answer to said question or the maximum number of attempts to answer the question is exhausted. When a correct answer to the question, the device ascertains if there are remaining questions from the finite number questions that have not been attempted by the user, and upon ascertaining that at least one question of the finite number questions has not been attempted by the user, the device presents the user with an additional question that has not been attempted. If the user supplies an incorrect answer to the additional question, the user chooses to either accept the incorrect answer to the additional question, or to repeat an attempt to answer the additional question with new parameters. If the maximum number of attempts to answer the additional question is not exhausted, the learning device supplies new parameters to the additional question and presents the additional question with new parameters to the user, and the learning device reduces the available maximum number attempts to answer the additional question by one. The learning device continues to present the user with the additional question, with new parameters, until either the user supplies a correct answer to the additional question or the maximum number of attempts to answer the additional question is exhausted. When the maximum number of attempts for each question that is answered incorrectly is exhausted, and the required minimum number of correct answers for questions from the finite number of questions is not met by the user, the learning device terminates the assignment with no credit given. If the required minimum number of correct answers for questions from the finite number of questions is met by the user prior to exhausting the available questions, the learning device terminates the assignment with full credit given.

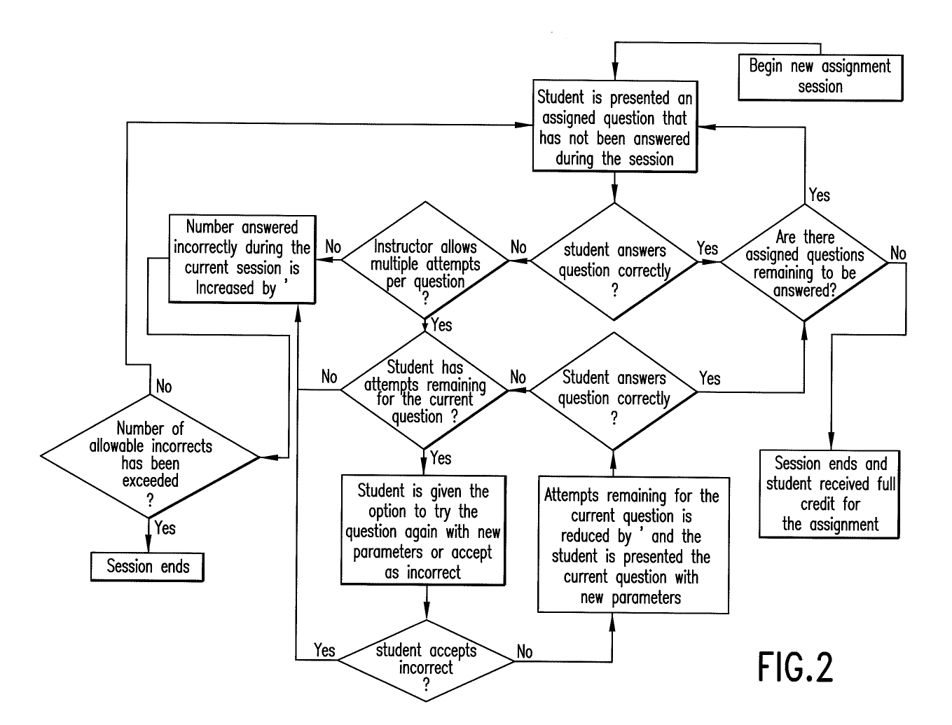

FIG. 2 provides a flow chart of a preferred embodiment of the invention.

### Example of a Preferred Embodiment of the Invention Demonstrating Possible Outcomes

By way of example, and not limitation, the device is provided with a set of possible questions for presentation to a user. Another person, such as an instructor, is provided with the set of questions or a subset thereof. In a specific example, the lesson or assignment is directed to adding integer numbers (“integers”), and the set of multiple questions is directed to the subject of the lesson assignment.

The questions may be separated into types of questions, and any number of types of questions, and any number of questions of each type, may be selected and assigned by the instructor to the student user. The assignment may require a minimum number of correct answers for the aggregate number of questions of all types, or the assignment may require a minimum number of correct answers for each type of question, in order for the user to receive full credit. The number of questions of each type that are assigned may vary according to each type of questions. By way of example, the questions may be directed to formats of adding integers, such as:

Type A: adding two integers

Type B: adding three integers

Type C: adding four integers

The instructor chooses to assign 3 occurrences (questions) of type A, 2 occurrences of type B, and 0 occurrences of type C. More or fewer types of questions could be provided to the device. The assignment in this example is directed to 5 total questions, although the instructor could choose more or fewer questions. The instructor chooses to allow 1 incorrect answer, although the instructor could choose more or less incorrect answer allowances. Alternatively, the instructor could, for example, allow a certain number of incorrect answers for each type of question, with each type of question having a different number of questions and a different, or same, number of incorrect answers permitted for each type. However, in this example, if the student user answers any 4 of the aggregate of 5 assigned questions correctly, the student receives full credit for the assignment, although a different ratio could be selected. The instructor chooses to allow two attempts per question, although fewer or greater attempts could be selected. The instructor provides these parameters to the device, thereby creating a customized assignment for the user.

### Scenario 1

The student user accesses the device, which may be a computer to which the instructor or student user downloads the customized assignment prepared by the instructor. The device may be programmable.

The first question is generated by the device. Since occurrences are available for each of the two assigned types according to the example, any of the questions of any of the assigned types of questions may be randomly generated as the first question. By way of example, the first question generated is one of the 2 available occurrences for type B. Three integers are randomly generated by the device for the question and the student user is presented with a question or problem asking the student user to solve the problem by correctly adding the three integers. The student solves the problem and answers the question correctly.

Since assigned questions remain, the student is then presented with question 2, which is randomly selected by the device from the remaining occurrences for type A and B. By way of example, the second available occurrence of a type B problem or question is presented to the student user. Three integers are randomly generated for the question and the student is asked to add the three integers. The student solves the problem and answers question 2 correctly.

The student is then presented with question 3. Occurrences of assigned questions remain for question type A only, so two random integers are generated and the student is asked to add the two integers. The student solves the problem and answers question 3 correctly.

The student is then presented with question 4.Occurrences remain for question type A only, so two random integers are generated and the student is asked to add the two integers. The student user solves the problem and answers question 4 correctly.

The student answered the required number of questions correctly. Full credit on the assignment is given to the student user without presenting question 5 and without presenting a numerical score.

### Scenario 2

The student user accesses the device, which may be a computer to which the instructor or student user downloads the customized assignment prepared by the instructor.

The first question is generated by the device. Since occurrences are available for each of the two assigned types according to the example, any of the questions of any of the assigned types of questions may be randomly generated as the first question. By way of example, the first question generated is one of the 2 available occurrences for type B. Three integers are randomly generated by the device for the question and the student user is presented with a question or problem asking the student user to solve the problem by correctly adding the three integers. The student solves the problem and answers the question correctly.

The student is then presented with question 2, which is randomly selected by the device from the remaining occurrences for type A and B. By way of example, the second available occurrence of a type B problem or question is presented to the student user. Three integers are randomly generated for the question and the student is asked to add the three integers. The student solves the problem and answers question 2 correctly.

The student is then presented with question 3. Occurrences are only remaining for question type A, so two random integers are generated and the student is asked to add the two integers. The student solves the problem and answers question 3 correctly.

The student is then presented with question 4. Occurrences are only remaining for question type A, so two random integers are generated and the student is asked to add the two integers. The student fails to solve the problem and answers question 4 incorrectly.

Since this is the student's first attempt at question 4, the student is told by messaging from the device that he/she has one attempt remaining for this question, and the student user is given the option to try the question again with new parameters, or accept an incorrect for question 4 and proceed to question 5.

The student chooses to attempt question 4 again with new parameters. Two new random integers are generated and supplied to the question by the device, and the student is asked to add the two integers. On this attempt, the student answers correctly.

The student answered the required number of questions correctly. Full credit on the assignment is given to the student user without presenting question 5 and without presenting a numerical score.

### Scenario 3

The student user accesses the device, which may be a computer to which the instructor or student user downloads the customized assignment prepared by the instructor.

The first question is generated by the device. Since occurrences are available for each of the two assigned types of questions according to the example, any of the questions of any of the assigned types of questions may be randomly generated as the first question. By way of example, the first question generated is one of the 3 available occurrences for type A. Two integers are randomly generated by the device for the question and the student user is presented with a question or problem asking the student user to solve the problem by correctly adding the two integers. The student solves the problem and answers the question correctly.

The student is then presented with question 2,randomly selected from the remaining occurrences for type A and B. The device randomly selects one of the available occurrences of type B. Three integers are randomly generated by the device for the question and the student is asked to add the three integers. The student fails to solve the problem and answers question 2 incorrectly.

Since this is the student's first attempt at question 2, the student is told by messaging from the device that he/she has one attempt remaining for this question, and given the option to try the question again with new parameters or accept an incorrect for question 2 and proceed to question 3.

The student chooses to attempt question 2 again with new parameters. Three new random integers are generated by the device and the student is asked to add the three integers. On this attempt, the student again answers incorrectly.

Since the student has exhausted both attempts for question 2, the student must accept the incorrect result and move on to question 3.

The device presents the student with question 3, randomly selected from the remaining occurrences for type A and B. By way of example, the device selects the second available occurrence of type B, so three random integers are generated and the student is asked to add the three integers. The student answers question 3 correctly. Type B occurrences are exhausted, according to the parameters set by the instructor and provided to the device in creating the customized lesson.

The device presents the student with question 4, randomly selected from the remaining occurrences for type A. Two random integers are generated by the device, and the student is asked to add the two integers. The student solves the problem and answers question 4 correctly.

The student is then presented with question 5, randomly selected from the remaining occurrences for type A. Two random integers are generated by the device, and the student is asked to add the two integers. The student solves the problem and answers question 5 correctly.

The student answered the required number of questions correctly. Full credit on the assignment is given to the student user without presenting a numerical score.

### Scenario 4

The student user accesses the device, which may be a computer to which the instructor or student user downloads the customized assignment prepared by the instructor.

The first question is generated by the device. Since occurrences are available for each of the two assigned types according to the example, any of the questions of any of the assigned types of questions may be randomly generated as the first question. By way of example, the first question generated is one of the 3 available occurrences for type A. Two integers are randomly generated by the device for the question and the student user is presented with a question or problem asking the student user to solve the problem by correctly adding the two integers. The student solves the problem and answers the question correctly.

The student is then presented with question 2,randomly selected from the remaining occurrences for type A and B. The device randomly selects one of the available occurrences of type B. Three integers are randomly generated by the device for the question and the student is asked to add the three integers. The student fails to solve the problem and answers question 2 incorrectly.

Since this is the student's first attempt at question 2, the student is told by messaging from the device that he/she has one attempt remaining for this question, and given the option to try the question again with new parameters or accept an incorrect for question 2 and proceed to question 3.

The student chooses to accept the incorrect result and proceed to question 3.

The device presents the student with question 3, randomly selected from the remaining occurrences for type B. Three random integers are generated by the device, and the student is asked to add the three integers. The student solves the problem and answers question 3 correctly. Type B occurrences are exhausted, according to the parameters set by the instructor and provided to the device in creating the customized lesson.

The student is then presented with question 4 by the device. Two random integers are generated and the student is asked to add the two integers. The student solves the problem and answers question 4 correctly.

The student is then presented with question 5. Two random integers are generated and the student is asked to add the two integers. The student solves the problem and answers question 5 correctly.

The student answered the required number of questions correctly. Full credit on the assignment is given to the student user without presenting a numerical score.

### Scenario 5

The student user accesses the device, which may be a computer to which the instructor or student user downloads the customized assignment prepared by the instructor.

The first question is generated by the device. Since occurrences are available for each of the two assigned types according to the example, any of the questions of any of the assigned types of questions may be randomly generated as the first question. By way of example, the first question generated is one of the 3 available occurrences for type A. Two integers are randomly generated by the device for the question and the student user is presented with a question or problem asking the student user to solve the problem by correctly adding the two integers. The student solves the problem and answers the question correctly.

The student is then presented with question 2, randomly selected by the device from the remaining occurrences for type A and B. By way of example, the device selects one of the available occurrences of type A. Two integers are randomly generated for the question and the student is asked to add the two integers. The student solves the problem and answers question 2 incorrectly.

Since this is the student's first attempt at question 2, the student is told by messaging from the device, he/she has one attempt remaining for this question, and is given the option to try the question again with new parameters or accept an incorrect for question 2 and proceed to question 3.

The student chooses to attempt question 2 again with new parameters. Two new random integers are generated by the device and the student is asked to add the two integers. On this attempt, the student again answers incorrectly. Since the student has exhausted both attempts for question 2, the student must accept the incorrect result and move on to question 3.

The student is presented by the device with question 3, randomly selected from the remaining occurrences for type A and B. By way of example, the device selects one of the available occurrences of type B, so three random integers are generated, and the student is asked to add the three integers. The student solves the problem and answers question 3 correctly.

The student is then presented with question 4, randomly selected by the device from the remaining occurrences for type A and B, for instance the second occurrence of type B. Three random integers are generated and the student is asked to add the three integers. The student fails to solve the problem and answers question 4 incorrectly.

Since this is the student's first attempt at question 4, the student is told by messaging from the device he/she has one attempt remaining for this question, and is given the option to try the question again with new parameters or accept an incorrect for question 4 and proceed to question 5.

The student chooses to attempt question 4 again with new parameters. Three new random integers are generated and the student is asked to add the three integers. On this attempt, the student also answers incorrectly.

Since the student has exhausted both attempts for question 4, the student must accept the incorrect result. However, the student has now also exceeded the allowable number incorrect and must attempt the assignment again from the beginning to earn full credit for the assignment, so the current session of the assignment is ended. No credit on the assignment is given to the student user. No score of correct or incorrect answers is presented to the student user, either by number of correct or incorrect answers, or by percentage.

### Scenario 6

The student user accesses the device, which may be a computer to which the instructor or student user downloads the customized assignment prepared by the instructor.

The first question is generated by the device. Since occurrences are available for each of the two assigned types according to the example, any of the questions of any of the assigned types of questions may be randomly generated as the first question. By way of example, the first question generated is one of the 3 available occurrences for type A. Two integers are randomly generated by the device for the question and the student user is presented with a question or problem asking the student user to solve the problem by correctly adding the two integers. The student solves the problem and answers the question correctly.

The student is then presented with question 2, randomly selected from the remaining occurrences for type A and B. The device randomly selects one of the available occurrences of type B. Three integers are randomly generated by the device for the question and the student is asked to add the three integers. The student fails to solve the problem and answers question 2 incorrectly.

Since this is the student's first attempt at question 2, the student is told by messaging from the device, he/she has one attempt remaining for this question, and is given the option to try the question again with new parameters or accept an incorrect for question 2 and proceed to question 3. The student chooses to accept the incorrect result and proceed to question 3.

The device presents the student with question 3, randomly selected from the remaining occurrences for type A and B. The second available occurrence of type B is selected. Three random integers are generated and the student is asked to add the three integers. The student answers question 3 incorrectly.

The student chooses to accept the incorrect result and proceed to question 4. However, the student has now also exceeded the allowable number of incorrect answers, and must attempt the assignment from the beginning to earn full credit for the assignment. The current session of the assignment is ended. No credit on the assignment is given to the student user. No score of correct or incorrect answers is presented to the student user, either by number of correct or incorrect answers, or by percentage.

### Scenario 7

In the student assignment application, the student downloads the customized assignment. The first question is generated by the device. Since occurrences are available for each of the two assigned types according to the example, any of the questions of any of the assigned types of questions may be randomly generated as the first question. By way of example, the first question generated is one of the 3 available occurrences for type A. Two integers are randomly generated by the device for the question and the student user is presented with a question or problem asking the student user to solve the problem by correctly adding the two integers. The student solves the problem and answers the question correctly.

The student is then presented with question 2, randomly selected by the device from the remaining occurrences for type A and B. One of the available occurrences of type A is selected. Two integers are randomly generated for the question and the student is asked to add the two integers. The student answers question 2 incorrectly.

Since this is the student's first attempt at question 2, the student is told by messaging from the device he/she has one attempt remaining for this question, and is given the option to try the question again with new parameters or accept an incorrect for question 2 and proceed to question 3.

The student chooses to attempt question 2 again with new parameters. Two new random integers are generated by the device and the student is asked to add the two integers. On this attempt, the student also answers incorrectly. Since the student has exhausted both attempts for question 2, the student must accept the incorrect result and move to question 3.

The student is presented question 3, randomly selected by the device from the remaining occurrences for type A and B. The device selects one of the available occurrences of type B. Three random integers are generated and the student is asked to add the three integers. The student solves the problem and answers question 3 correctly.

The device presents the student with question 4, randomly selected from the remaining occurrences for type A and B. The device selects the second occurrence of type B. Three random integers are generated and the student is asked to add the three integers. The student answers question 4 incorrectly.

Since this is the student's first attempt at question 4, the student is told by messaging from the device that he/she has one attempt remaining for this question, and is given the option to try the question again with new parameters or accept an incorrect for question 4 and proceed to question 5. The student chooses to accept the incorrect result and proceed to question 5. However, the student has exceeded the allowable number of incorrect answers, and must attempt the assignment again from the beginning to earn full credit for the assignment. The current session of the assignment is ended. No credit on the assignment is given to the student user. No score of correct or incorrect answers is presented to the student user, either by number of correct or incorrect answers, or by percentage.

What is claimed is:

1. A learning device for promoting the learning of skills and concepts, comprising:
a learning device comprising a display, wherein:
an assignment is provided into the learning device for presentation to a user by means of the display, said assignment comprising a finite number of questions, a maximum number of attempts to answer each of the finite number of questions, and a required minimum number of correct answers to the finite number of questions that is less than or equal to the finite number of questions;
wherein, the learning device presents the user with a question from the finite number of questions that has not been attempted, and if the user supplies an incorrect answer to the question, the user chooses to either accept the incorrect answer, or to repeat an attempt to answer the question with new parameters, whereupon if the maximum number of attempts to answer the question is not exhausted, the learning device supplies new parameters to the question and presents the question with new parameters to the user, and the learning device reduces the available maximum number attempts to answer the question by one.

2. A learning device for promoting the learning of skills and concepts as described in claim 1, wherein the learning device continues to present the user with said question from the finite number of questions with new parameters until either the user supplies a correct answer to said question or the maximum number of attempts to answer the question is exhausted.

3. A learning device for promoting the learning of skills and concepts as described in claim 1, whereupon when a correct answer to the question from the finite number of questions is provided by the user, the learning device ascertains whether at least one question of the finite number questions has not been attempted by the user, and upon ascertaining that at least one question of the finite number questions has not been attempted by the user, the learning device presents the user with an additional question that has not been attempted by the user, and whereupon, when the user supplies an incorrect answer to the additional question, the user chooses to either accept the incorrect answer to the additional question, or to repeat an attempt to answer the additional question with new parameters, and when the user elects to repeat the attempt to answer the additional question and the maximum number of attempts to answer the additional question is not exhausted, the learning device supplies new parameters to the additional question and presents the additional question with new parameters to the user, and the learning device reduces the available maximum number attempts to answer the additional question by one.

4. A learning device for promoting the learning of skills and concepts as described in claim 3, wherein the learning device continues to present the user with said additional question from the finite number of questions with new parameters until either the user supplies a correct answer to said additional question or the maximum number of attempts to answer the additional question is exhausted.

5. A learning device for promoting the learning of skills and concepts as described in claim 3, wherein when the maximum number of attempts for each question that is answered incorrectly is exhausted, and the required minimum number of correct answers for questions from the finite number of questions is not met by the user, the learning device terminates the assignment with no credit given.

6. A learning device for promoting the learning of skills and concepts as described in claim 3, wherein when the required minimum number of correct answers for questions from the finite number of questions is met by the user, the learning device terminates the assignment with full credit given.

7. A learning device for promoting the learning of skills and concepts as described in claim 1, wherein the assignment comprises multiple types of questions, a finite number of questions of each type of the multiple types of questions, a maximum number of attempts to answer each of the questions, and a required minimum number of correct answers to the finite number of questions that is less than or equal to the finite number of questions.

8. A learning device for promoting the learning of skills and concepts as described in claim 7, wherein a minimum number of correct answers is assigned for each type of the multiple types of questions for full credit to be given to the user.

9. A learning device for promoting the learning of skills and concepts as described in claim 1, wherein the questions are math questions, if the user fails to provide a correct answer to a single question and the user elects to attempt the single question again within the permitted maximum number of attempts, the device randomly generates a new number within the parameters of the question and replaces a number in the question with the new number.

10. A learning device for promoting the learning of skills and concepts as described in claim 1, wherein the finite number of questions for the assignment is chosen from a plurality of subsets of questions, each of the subsets having different criteria from another of the subsets, and a finite number of questions is chosen from said subsets.

11. A learning device for promoting the learning of skills and concepts as described in claim 1, wherein the assignment is downloaded to the learning device from a portable storage device into which the assignment is programmed.

12. A learning device for promoting the learning of skills and concepts as described in claim 1, wherein the assignment is downloaded to the learning device from a portable storage device into which the assignment is programmed and which is remote from the learning device.

13. A learning device for promoting the learning of skills and concepts as described in claim 1, wherein a plurality of assignments are provided to the learning device and the user chooses the assignment from the plurality of assignments.

14. A learning device for promoting the learning of skills and concepts as described in claim 1, wherein a plurality of assignments are loaded onto a storage device and the user chooses the assignment from the plurality of assignments and downloads the assignment from storage device into the learning device.

15. A learning device for promoting the learning of skills and concepts as described in claim 1, wherein the number of questions to be answered by the user, the maximum number of attempts to answer each of the questions, and the required minimum number of correct answers to the questions are each selectable and are selected by an instructor who is not the user.
